(19) United States
(12) Patent Application Publication
(10) Pub. No.: US 2013/0111345 A1
(43) Pub. Date: May 2, 2013

(54) PORTABLE ELECTRONIC DEVICE, ASSOCIATED APPARATUS AND METHODS

(71) Applicants: John-Rhys Newman, Woodland Hills, CA (US); Pascal Wever, Los Angeles, CA (US); Marco Paglia, San Francisco, CA (US); Duncan Burns, Santa Monica, CA (US); Julian Bleecker, Los Angeles, CA (US); Jacob Zukerman, San Francisco, CA (US); Timothy Ong, Concord, CA (US)

(72) Inventors: John-Rhys Newman, Woodland Hills, CA (US); Pascal Wever, Los Angeles, CA (US); Marco Paglia, San Francisco, CA (US); Duncan Burns, Santa Monica, CA (US); Julian Bleecker, Los Angeles, CA (US); Jacob Zukerman, San Francisco, CA (US); Timothy Ong, Concord, CA (US)

(73) Assignee: NOKIA CORPORATION, Espoo (FI)

(21) Appl. No.: 13/285,682

(22) Filed: Oct. 31, 2011

(51) Int. Cl. G06F 3/048; G06F 3/01

(52) U.S. Cl. 715/716; 715/764

(57) ABSTRACT

A portable electronic device with first and second modes,
the first mode, associated with allowing for the availability of one or more of a first level of power consumption and processor activity for the portable electronic device, and allowing general unlocked user interaction with the user interface of the portable electronic device;
the second mode, associated with allowing for the availability of one or more of a second level of power consumption or processor activity, and allowing locked user interaction with the user interface; and
the locked user interaction allowing for the provision of one or more specific limited user inputs using the user interface, to directly interact with associated second mode output provided using the user interface in the second mode, the one or more specific limited user inputs not being associated with general unlocking of portable electronic device to enter the first mode of operation.

### TECHNICAL FIELD

The present disclosure relates to the field of portable electronic device modes, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Portable electronic devices may enable one or more applications to be opened. Generally, an application allows the user to access functionality of the portable electronic device (e.g. use an email application to write a message for transmittal), identify location related information, connect to another device, or to access information (e.g. use a web browser to read a news website) using the device. When a device is in a fully active mode, the full range of functionality and information provided by the one or more application(s) are generally available to the user (unless there are additional security restrictions associated with a particular applications—even in this case, at least the user would be able to try to get access to the application or be presented with at least some information associated with such an application). If multiple applications are used, a significant amount of processor activity and/or power would be required. Under such a fully active mode therefore, there would not be a restriction on processor activity and/or power usage so that the user can access multiple applications.

In order to lower processor activity and/or power consumption (e.g. to extend battery life) the user may turn off the portable electronic device, or enter a mode wherein user interaction with the portable electronic device is prevented and functionality is disabled (other than allowing the user to return the portable electronic device to the active mode).

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code configured to, with the at least one processor, cause the apparatus to perform at least the following:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

A mode of operation of the portable electronic device may be considered to be an operational state of the portable electronic device. For example, the mode of operation may dictate the applications available, the hardware (e.g. keypad, memory, transmitter) which is enabled or disabled, the functionality available (e.g. transmission of data may be enabled in a first mode but not in a second mode), the information available, how the information is presented, and/or how the user can interact with the portable electronic device (e.g. whether an aspect of the user interface, such as a keyboard, is enabled, disabled and/or configured to respond in a different way to the same input). That is, mode of operation may define the behaviour (e.g. default behaviour) and/or capabilities of the portable electronic device (and possible applications running on the portable electronic device). The mode of operation may dictate what information is supplied to the user and/or the functions available to the user.

The second mode may be a user-defined mode of operation (e.g. a mode of operation with user-saved preferences). The mode of operation of the portable electronic device when an application is running in may dictate the behaviour of the application.

The associated second mode output may comprise output from one or more of a plurality of second mode user applications.

A plurality of first mode applications may be available in the first mode of operation, and the plurality of second mode applications may be a subset of the plurality of first mode applications.

The associated second operating mode output of each of the plurality of second mode applications may comprise abbreviated output, abbreviated output being an abbreviated version of output available for the application when in the first mode of operation.

The specific limited user input may allow scrolling between the applications of the plurality of second mode applications (e.g. by swiping on a touch screen, using a scroll bar interface).

Each said second mode application may be a first mode application.

The associated second mode output of the selected second mode application may comprise abbreviated output, abbreviated output being an abbreviated version of output available for the selected second mode application when in the first mode. For example, in the case of a map application, just a portion of the information available in the first mode would be available in the second mode. An abbreviated version may be considered to be a reduced version, and/or a redacted version.

The abbreviated output may comprise one or more of:
a subject of a textual message;
a first line of a textual message;
a first predetermined number of characters of a textual message;
information identifying the sender of a textual message;
a news headline;
information detected in, and extracted from a message (e.g. name, address, telephone number);
a direction indicator; and
a location indicator.

Second mode output may be, for example, one or more of: visual output (e.g. image, text); tactile output (e.g. haptic feedback); and audio output.

The portable electronic device and/or selected second mode application may be configured to continuously provide second mode output (or refresh output at predetermined intervals) when the portable electronic device is in the second mode of operation. For example, if the second mode application were a navigation application or music player application, second mode output may be provided continuously (e.g. information relating to current location, information relating to direction indicator, information relating to current music being played) so that the user can access that information simply by looking at the device.

The portable electronic device and/or selected second mode application may be configured not to continuously provide second mode output when the portable electronic device is configured to be in the second mode of operation. For example, if the second mode application were a blogging application or email (or other messaging) application, second mode output may be provided only in response to an event (e.g. receipt of a message), or to a user interaction with the portable electronic device.

Two or more of a plurality of user applications may be available in the first mode of operation, the user applications comprising, for example, two or more of:
a game application;
an email application;
a navigation application (e.g. a satellite navigation application);
a social networking application;
a news feed application;
a web browser; and
a map application.

Two or more particular user applications may be selected as one or more selected second mode applications.

When in the second mode of operation, the associated second mode output may comprise navigation information associated with a navigation application, and the allowable specific limited user input may include changing the location of the portable electronic device. This may be, for example, as the user moves about with the portable electronic device.

The second mode output may comprise information relating to a received message from a third party and the specific limited user input may enable recording an audio message, and transmitting the recorded message to the third party. Thus, if a message is received, this is still provided to the user in the second mode, and the user is able to easily respond by recording an audio message from the second mode.

The second mode output may comprise information relating to the music file being played and the specific limited user input may enable the user to select a different music file to be played.

The specific limited user input may be limited with respect to the general range of user input available in the first mode. That is, the user input available in the second mode may be a subset of the user input available in the second mode. For example, an example embodiment may have a keyboard user interface and a joystick user interface, wherein in the first mode the user can provide input via both the keyboard user interface and a joystick user interface whereas in the second mode the user can provide input only via the joystick user interface (or even the range of input detectable by the keyboard and/or joystick may be limited in the second mode). In this way, the locked user interaction may be limited with respect to the general unlocked user interaction.

The locked user interaction available in the second mode of operation may be limited with respect to the general unlocked user interaction available in the first mode of operation. The locked user interaction may be a subset of the general unlocked user interaction. The general unlocked interaction may enable the user to interact with all of the applications of the device. The general unlocked interaction may enable the user to access all of the functionality of the device. The locked interaction may prevent the user, in the second mode, from accessing certain applications/functionality (which may be available in the first mode of operation).

The second level of the one or more of power consumption and processor activity may be lower than the first level of the one or more of power consumption and processor activity for the portable electronic apparatus.

The second mode of operation may allow for the user to provide specific limited user input to the portable electronic device using the user interface of the portable electronic device, to directly interact with associated output provided using the user interface in the second mode of operation, whilst keeping the portable electronic device in the second mode.

The apparatus may be configured to provide a third mode of operation for the portable electronic device, the third mode associated with allowing for the availability of one or more of a third level of power consumption or processor activity for the portable electronic device, the third level of one or more of power consumption and processor activity being lower than the second level.

The third mode may provide for a sleep mode in which user input in response to associated output cannot be provided without entering at least one of the first or second modes.

The apparatus may be configured to allow a user interaction to change the mode of the apparatus from one mode to a different mode.

The apparatus may be configured, when in the third mode, to disable user interaction with one or more applications configured to run on the apparatus but allow the user to unlock the portable electronic device to enter the first mode of operation.

The locked user interactions of the second mode may be locked with respect to the availability of one or more of the power source, processor and functionality of the user interface.

The apparatus may be configured to allow a user interaction to move from the third mode to the second mode in response to an event.

An event may comprise:
receipt of a message from a third party; or
an scheduled event.

A received message from a third party may comprise one or more of an SMS, an MMS, a photo message, an image-based message, a video message, an audio message, a social media website-based message, a micro-messaging based message, a web-site based message, a message associated with trading, a website forum-based message, or a hyperlink.

A scheduled event may comprise one or more of:
a calendar entry;
an alarm;
a scheduled software update;
a scheduled anti-virus update; and
a time and date based scheduled update.

A specific limited user input may comprise one or more of:
tilting the portable electronic device;
moving the portable electronic device to a new location (e.g. a new geographic location);
interacting with a touch screen;
pressing a touch screen;
hovering over a touch screen;
touching a particular region of the touch screen;
pressing a key; and
swiping on the touch screen.

Specific limited user input may allow for performance of the task associated with the second mode output, in the second mode.

Specific limited user input may allow for performance of the task associated with the second mode output, in the first mode before automatically returning the portable electronic device to the second mode.

The apparatus may be at least one of a portable electronic device, circuitry for a portable electronic device, a laptop computer, a desktop computer, a mobile phone, a Smartphone, a tablet PC, a monitor, a personal digital assistant or a digital camera or a module for the same.

The portable electronic device having the first and second modes may be considered to be the laptop computer, the desktop computer, the mobile phone, the Smartphone, the tablet PC, the monitor, the personal digital assistant or the digital camera.

The user interface may comprise a combination of one or more of a wand, a pointing stick, a touchpad, a touch-screen, a display, a stylus and pad, a mouse, a physical keyboard, a virtual keyboard, a joystick, a remote controller, a button, a microphone, a motion detector, a position detector, a scriber and an accelerometer.

The apparatus/portable electronic device may comprise a display, and the display may comprise a combination of one or more of an AMOLED (active-matrix organic light-emitting diode), an eInk display, a LCD (liquid crystal display). For example, a display may comprise an underlying eInk screen, and an LCD on top, wherein the LCD may be configured to be transparent or translucent when the eInk screen is in use. When in the second mode, the display may be configured such that it uses less power (e.g. by reducing the colour and/or brightness, and/or changing the colour scheme of the display). For example, a Quarter Video Graphics Array OLED display may consume 3 watts while showing black text on a white background, but only 0.7 watts showing white text on a black background. That is, changing the mode of operation of the portable electronic device may comprise changing the mode of a display of the portable electronic device.

One or more of the second level of power consumption and processor activity for the portable electronic device may be temporarily higher than the first level of power consumption and processor activity for the portable electronic device during processing and/or performance of the specific limited user input and/or the function/task associated with the specific limited user input.

Memory may comprise one or more of, for example, a CD, a DVD, flash memory, a floppy disk, a hard disk, volatile memory, non-volatile memory Random Access Memory.

The apparatus may be connected/connectable to a network. The network may be, for example, the internet, a mobile phone network, a wireless network, LAN or Ethernet. The apparatus may comprise a transmitter and or receiver to interact with a network. The transmitter/receiver may comprise, for example, an antenna, an Ethernet port, a LAN connection, a USB port, a radio antenna, Bluetooth connector, infrared port, or fibre optic detector/transmitter.

It will be appreciated that the second mode may not be an aeroplane or flight mode (e.g. where antenna transmitting and receiving functions are suspended). It will be appreciated that the second mode may not be a low battery mode, the low battery mode being activated in response to detecting that the battery level is below a predetermined threshold. It will be appreciated that the apparatus/portable electronic device may be configured to provide a flight mode and/or a low battery mode in addition to the second mode of operation.

In a second aspect, there is provided a method, the method comprising:
providing/using a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
providing/using a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

In a third aspect, there is provided a computer program comprising computer program code configured to:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

The computer program may be stored on a storage media (e.g. on a CD, a DVD, a memory stick or other non-transitory medium). The computer program may be configured to run on a device or apparatus as an application. An application may be run by a device or apparatus via an operating system.

In a fourth aspect, there is provided an apparatus, the apparatus comprising:
first means for providing configured to provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
second means for providing configured to provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an embodiment comprising a number of electronic components, including memory, a processor and a communication unit.

FIG. 2 illustrates an example embodiment comprising a touch-screen.

FIG. 3a-3g depicts the example embodiment of FIG. 2 wherein the plurality of second mode applications comprises a navigation application and a music player application.

FIG. 4a-4e depicts a further example embodiment wherein the plurality of second mode applications comprises a email application and a news feed application.

FIG. 5 depicts a flow diagram describing the method used to provide a portable electronic device with a first mode of operation and second mode of operation.

FIG. 6 illustrates schematically a computer readable media providing a program according to an example embodiment of the present invention.

### DESCRIPTION OF EXAMPLE ASPECTS/EMBODIMENTS

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It is common for a portable electronic device to have an active first mode (which may or may not be graphically based) to allow a user to generally interact with the portable electronic device and generally access the (full) functionality of the portable electronic device. For example, in the active mode, the user may be presented with a wide range of icons and options representing different available applications available for general use. Some electronic devices have a second mode (or sleep mode) where the full availability of options are disabled. For these devices the user is either presented, in an active mode, with an interface which allows complete interaction with the portable electronic device and, in the sleep/standby mode, with an interface which inhibits full interaction with the portable electronic device (but allows for unlocking of the device to enter the general mode). Other phones (e.g. Nokia N8) may allow the user to lock and unlock the device (e.g. by using a slider on the side of the phone or by pressing a sequence of keys). In the unlocked mode the user may have general unlocked access to all applications and/or to the full functionality of the phone. In locked mode, the user may be able to receive a phone call, view a screen saver, but user applications and/or functionality are not available.

Example embodiments contained herein may be considered to provide a way of providing a mode of operation with intermediate functionality, information and/or interaction. For example, it may allow the user to access provided functionality, information and/or interaction directly and unambiguously, (e.g. without having to navigate or consider other functionality/information provided in a different mode).

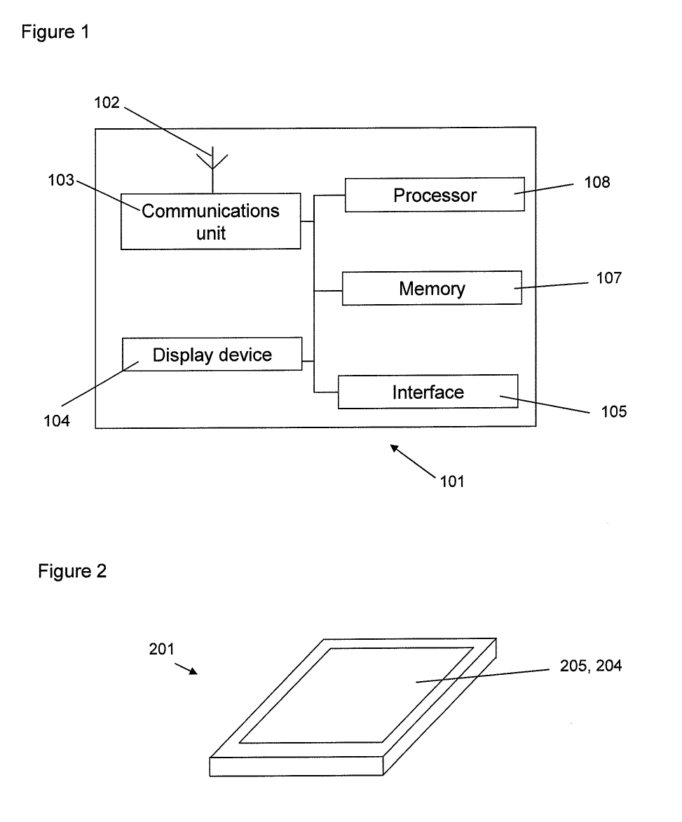

FIG. 1 depicts an apparatus (101) of an example embodiment, such as a mobile phone. In other example embodiments, the apparatus (101) may comprise a module for a mobile phone (or PDA or audio/video player), and may just comprise a suitably configured memory (107) and processor (108).

The example embodiment of FIG. 1, in this case, comprises a display device (104) such as, for example, a Liquid Crystal Display (LCD) or touch-screen user interface. The apparatus (101) of FIG. 1 is configured such that it may receive, include, and/or otherwise access data. For example, this example embodiment (101) comprises a communications unit (103), such as a receiver, transmitter, and/or transceiver, in communication with an antenna (102) for connecting to a wireless network and/or a port (not shown) for accepting a physical connection to a network, such that data may be received via one or more types of networks. This example embodiment comprises a memory (107) that stores data, possibly after being received via antenna (102) or port or after being generated at the user interface (105). The processor (108) may receive data from the user interface (105), from the memory (107), or from the communication unit (103). It will be appreciated that, in certain example embodiments, the display device (104) may incorporate the user interface (105). Regardless of the origin of the data, these data may be outputted to a user of apparatus (101) via the display device (104), and/or any other output devices provided with apparatus. The processor (108) may also store the data for later use in the memory (107). The memory (107) may store computer program code and/or applications which may be used to instruct/enable the processor (108) to perform functions (e.g. read, write, delete, edit or process data).

This example embodiment is configured to enable a plurality of modes of operation, the plurality of modes of operation comprising a first mode of operation and a second mode of operation. The first mode of operation is configured to allow general unlocked user interaction with the user interface (105) of the portable electronic device (101), and is associated with allowing for the availability of one or more of a first level of power consumption and processor (108) activity for the portable electronic device.

The second mode is configured to allow locked user interaction with the user interface (105) of the portable electronic device, and is associated with allowing for the availability of one or more of a second level of power consumption or processor (108) activity for the portable electronic device.

When changing from the first mode of operation to the second mode of operation, the portable electronic device may, for example, be configured to perform one or more of: change the mode of the display device to a low power mode (e.g. by lowering the brightness of the screen (104)); limit the amount of processing activity available; disabling part of the user interface (105) (e.g. such that a portion of the touch user interface is not configured to respond to user input); limit the amount of non-persistent memory (107) available (e.g. RAM); disable predetermined hardware (e.g. transmitter, receiver, communications unit (103)); and enable running of applications in a second mode.

The locked user interaction of the second mode of operation allows for the user to provide one or more specific limited user inputs (e.g. limited compared to the general interaction input available in the first mode) to the portable electronic device using the user interface (105) of the portable electronic device, to directly interact with associated second mode output provided using the user interface (105) in the second mode of operation, the one or more specific limited user inputs not being associated with general unlocking of portable electronic device to enter the first mode of operation.

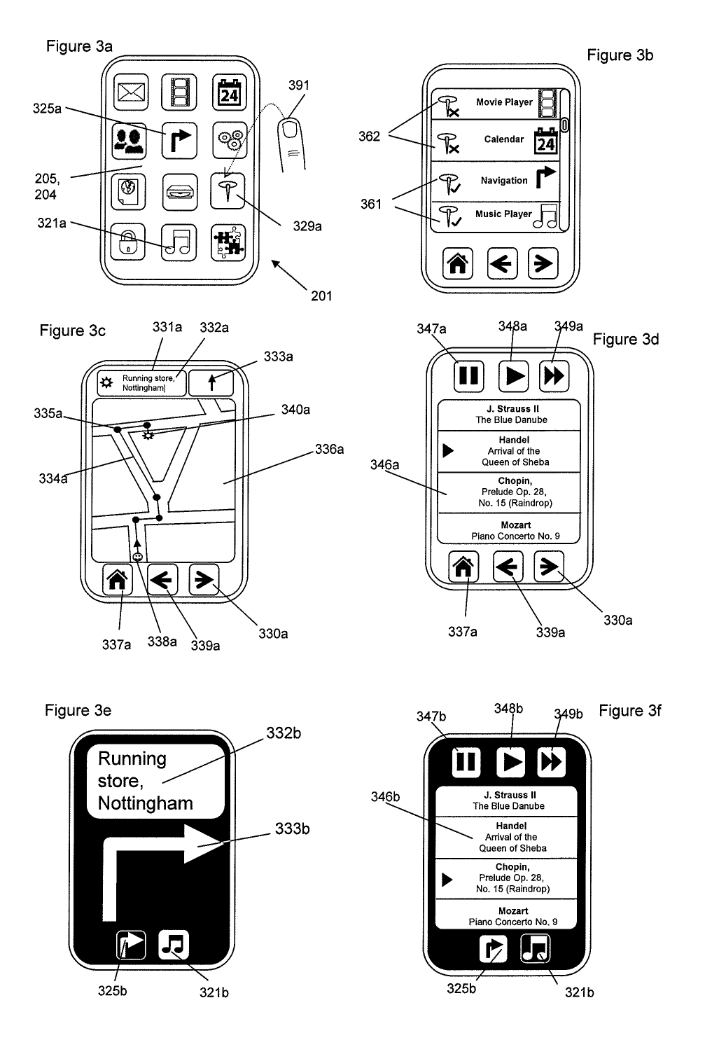

FIG. 2 depicts an example embodiment of the apparatus comprising a portable electronic device (201), e.g. such as a mobile phone, with a user interface comprising a touch-screen user interface (205, 204), a memory (not shown), a processor (not shown) and an antenna (not shown) for transmitting and/or receiving data (e.g. emails, textual messages, phone calls, information corresponding to web pages).

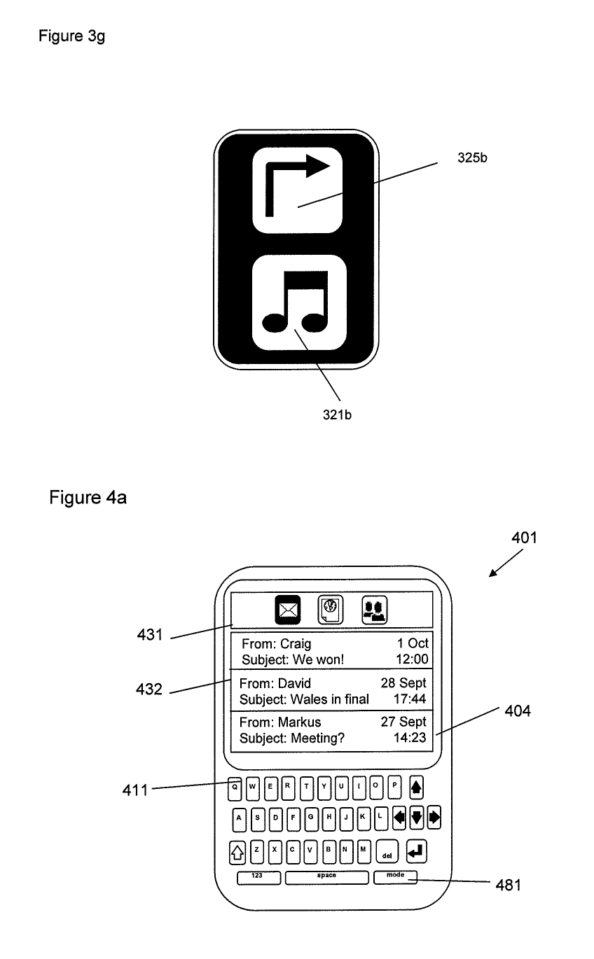

FIG. 3a-f illustrates a series of views of the example embodiment of FIG. 2 when the mobile phone portable electronic device (201) is in use. In this example, the user wants to go to a running/athletics store in Nottingham, in the UK, and listen to music at the same time. The first screen presented to the user in the first active mode when the portable electronic device is turned on is a home screen (as depicted in FIG. 3a). The home screen displays a number of user interface element icons, each user interface element icon representing a different application which the user can select and interact with when the portable electronic device is in the first active mode. In this case the applications comprises, an email client, a movie player, a calendar application, a messaging application, a navigation application, a settings control application, a web browser application, a external device interface application, a pinning selection application (discussed further below), a locking application, an music player application, and a games application.

To allow the two desired applications (i.e. the navigation application and the music player application) to provide second mode output (and to allow the user to interact with the second mode output), the user opens the pinning selection application by selecting the pinning selection application icon (329a) (by pressing or hovering with his finger (391)). When the pinning selection application is open, a scrollable list is displayed giving the available plurality of applications. The user can select from this list which applications are to provide second mode output when the portable electronic device is in the second mode of operation. In the situation depicted in FIG. 3b, the user has selected the navigation application and the music player application. The selection is denoted by pin selected icons (361). Applications which are not selected are each denoted by a pin unselected icon (362). It will be appreciated that certain embodiments, the device may allow any running applications from the first (active) mode to be make available in the second mode i.e. without user pinning. The applications available in both modes may not be user-selectable but pre-set/predefined in the device (or configurable by connection to a remote apparatus e.g. server).

In this example, the user wishes to get directions to a particular store so returns to the home screen and selects the navigation application by pressing (or hovering over), with his finger (391) (or other stylus) on the corresponding navigation application icon user interface element (325a). This opens the navigation application.

In the situation depicted in FIG. 3c, the portable electronic device remains configured to be in a first (active) mode, the first (active) mode being configured to provide general unlocked user interaction with the user interface of the portable electronic device. In this case, the general unlocked user interaction allows the user to enter the desired location (332a) into a location entry field (331a) of the navigation application. The apparatus is configured to determine the current geographical location (e.g. using global positioning system), and a route from the determined current geographical location to the entered location based on a map (e.g. which may be stored on the portable electronic device, or on a remote device such as a server). To make these determinations and present the results of the determinations the portable electronic device has, in the first mode, one or more of a first (active) level of power consumption and processor activity available (which would be unrestricted, but not necessarily so e.g. in the case that the device has a further active mode which can provide for a battery life which is double (or extended with respect to) the first active mode by, for example, limiting WLAN scanning or the number of background applications which can be run).

When the portable electronic device has determined a route from the current position to the entered desired location, the display is configured to present on the display: a desired location entry field (331a) where the user can enter/edit where the desired location is; a map region (336a), indicating the user's present location (338a), the location of the entered desired location (340a), a route (334a) wherein each change of direction is indicated by a direction change marker (335a); a direction indicator (333a) configured to indicate what direction the user has to travel from his current location to follow the route (334a); a home icon (337a) configured to allow the user to return to the home screen; a back icon (339a) configured to allow the user to return to the last screen; and a pin select icon (330a) configured to allow the user to select the application as a particular second mode application.

The user can then, in the first mode, use the map of the route and the direction indicator to follow the route to his desired location. As the user changes location, the apparatus is configured to update the user's current position and corresponding route map.

The user also wants to listen to particular music whilst he is en route. He therefore returns to the home screen and selects the navigation application by pressing (or hovering over), with his finger (391) (or other stylus) on the corresponding music player application icon user interface element (321a). This opens the music player application.

In the situation depicted in FIG. 3d, the portable electronic device is still configured to be in a first (active) mode, the first (active) mode being configured to provide general unlocked user interaction with the user interface of the portable electronic device. In this case, the general unlocked user interaction allows the user to select a particular song or tune from a list (346a) of stored music files in order to play that music file. The user interface also allows the user to pause, play or skip songs by selecting (by pressing or hovering over with a finger (391) or other stylus) corresponding pause (347a), play (348a) and skip (349a) user interface elements.

After a predetermined period since the last user interaction with the touch screen, the apparatus is configured to automatically enter a second (locked) mode (depicted in FIG. 3c). The second (locked) mode, in this example embodiment, is configured to allow locked user interaction with the user interface of the portable electronic device and is associated with allowing for the availability of one or more of a second level of power consumption or processor activity for the portable electronic device. In this case, the second level of power consumption or processor activity is lower than the first level of power consumption or processor activity available in the first mode. For example, the portable electronic device may be configured to update the user's current position and route map (for the navigation application) less frequently in the second mode than in the first mode. It will be appreciated that by lowering available power consumption or processor activity may help to extend battery life when the portable electronic device is in the second mode. For this embodiment, the screen is placed in a low power mode by configuring the pixels corresponding to the background to be turned off (making them black) and configuring the pixels corresponding to text and user interface elements to be white. This reduces the power consumption of the screen whilst the portable electronic device is on the second mode. It will be appreciated that other example embodiments may be configured to turn all or portions of a screen into a low power mode (e.g. by turning off a backlight, reducing the contrast, selecting colour schemes which reduce power). Such forms of output can be considered to be low power output. Available power consumption and/or processor activity is also restricted by reducing the number of applications which are available to be accessed/run in the second mode.

When in the second (locked) mode, the associated second mode output comprises information associated with the plurality of selected second mode applications, which in this case comprise the navigation application and the music player application.

When the user has selected the navigation application in the second mode (by selecting the navigation application second mode icon (325b) as depicted in FIG. 3e or provided automatically by the device in the second mode or by swiping between screens), the second mode output of the navigation second mode application comprises abbreviated output, abbreviated output being an abbreviated version of output available for the selected second mode application when in the first mode. That is, as in the first mode, the selected second mode application in the second mode provides output comprising a desired location (332b); and a direction indicator (333b) configured to indicate what direction the user has to travel from his current location to follow the route. However, unlike the view for the selected second mode application when in the first (active) mode, when in the second (locked) mode, the display does not show a map, a home icon configured to allow the user to return to the home screen; a back icon configured to allow the user to return to the last screen; and a pin select icon configured to allow the user to select the application as a particular second mode application. Furthermore, for this example embodiment, the desired location (332b) as shown in the second mode is not editable, whereas the desired location (332a) as shown in the first mode is editable by the user via an unlocked user interaction with the portable electronic device. In this case, the navigation application is configured to continuously provide second mode output (or refresh the output with a predetermined frequency) when the portable electronic device is configured to be in the second mode of operation. It will be appreciated that other example embodiments may be configured to provide audio second mode output. For example, a second mode navigation application may be configured to provide audio second mode output which would inform the user which direction to go and when to turn. In this way, the user may not need to look at the display of the portable electronic device. In this case the locked user interaction of the second mode of operation allows for the user to provide one or more specific limited user inputs to the portable electronic device, to directly interact with associated second mode output (332b, 333b) provided using the user interface (205) in the second mode of operation, the one or more specific limited user inputs not being associated with general unlocking of portable electronic device to enter the first mode of operation. In this case the specific limited user inputs (relating to the navigation application) comprise changing the geographical location of the portable electronic device. In this case, the specific limited user inputs for the navigation application do not comprise interacting directly with the touch screen. In this case the portable electronic device is configured to detect the geographical location specific user input by determining the geographical location, for example, using a global positioning system.

In this way the apparatus is configured to determine the position of the portable electronic device as it is moved towards the desired location. In this case, in response to the user providing geographical location specific limited user input (by changing geographical location) the apparatus is configured to update the direction indicator (333b).

For example, in the situation depicted in FIG. 3e, the user has reached the point where he needs to change direction in order to follow the route. In the first mode, the user's position would correspond, on the displayed map, to a first direction change marker. In this second mode, the portable electronic device is configured to update the direction indicator (333b) such that the user can continue to follow the route without leaving the second (locked) mode of the portable electronic device.

When the user has selected the music player application in the second mode (e.g. by selecting the music player application second mode icon (321b) as depicted in FIG. 3f or by swiping between screens), the second mode output of the navigation second mode application comprises unabbreviated output. That is, as in the first mode, the selected second mode application in the second mode provides output comprising a list of songs (346b). The locked user interaction available in the second mode of operation is nevertheless limited compared to the general unlocked user interactions available in the first mode of operation in that the user can not navigate, for example, to the home screen or to a user application which is not a second mode application. Furthermore, in order to pause, play or skip songs the user must select the corresponding user interface elements (347b, 348b, 349b) for a predetermined period of time. In this way the user interactions are limited with respect to the general user interaction available in the first mode of operation. It will be appreciated that requiring a more precise or specific user input in the second mode may prevent unwanted user interaction, for example when the portable electronic device is in the users pocket whilst in the second mode of operation. It will be appreciated that other example embodiments may provide other ways to interact with the second mode output (e.g. using physical keys; using different gestures, such as swiping, pressing, multi-touch gestures).

It will be appreciated that the apparatus/portable electronic device may be configured to change the appearance of an icon (e.g. by changing the colour of the icon or animating the icon) in response to an event relating to the corresponding application. For example, if an icon relating to an email application is being displayed, the icon may change colour in response to a new message being received. It will be appreciated that this may allow the user to be aware of new information being available even when the application is not being displayed.

It will be appreciated that for other example embodiments the second mode output may comprise an image (e.g. an album cover image alone, or an album cover image along with the artist and song for a music player application). The image second mode output (i.e. second mode output which comprises an image) may be displayed in full colour or with limited range of colours.

It will be appreciated that other embodiments may enable different applications to be switched between in different ways. For example, another example embodiment may allow the user to scroll between the second mode applications in the second mode.

Other example embodiments may be configured to simultaneously show all of the second mode output corresponding to the plurality of second mode user applications. It will be appreciated that other embodiments may be configured such that each second mode application provides abbreviated second mode output. It will be appreciated that other embodiments-may be configured such that, in the second mode, one application fills the screen at a time (e.g. with no icons displayed). In this case, when a first second mode application is being displayed a user could navigate to a second application by inputting a specific limited navigation input (e.g. swiping across the screen, pressing a navigation key). It will be appreciated that other embodiments may be configured such that, in the second mode, a first subset of the plurality of the second mode user applications are displayed on a first screen and a second subset of the plurality of the second mode user applications are displayed on a second screen. For example, a first screen may be configured to display second mode output from a news feed application, an email application and a messaging application and a second screen may be configured to display second mode output from a music application. In this way, the user may be able to navigate between the screens displaying the different subsets of second mode output. It will be appreciated that there may be more than two screens, each screen being configured to display a respective subset of the second mode output. It will be appreciated that a subset of the second mode output may comprise second mode output from a single application.

It will be appreciated that other example embodiments may allow the user to navigate between the plurality of second mode applications in different ways. For example, in the above described embodiment, the user was presented with icons along with the second mode output which allowed the user to change the second mode application which was displayed. Another example embodiment may allow the user to scroll or swipe between screens allowing the different user applications to be seen in the second mode. Another example embodiment may have a second mode home screen, wherein icons corresponding to the second mode applications would be displayed in the second mode. FIG. 3g shows what this second mode home screen might look like for the above described embodiment (it will be appreciated that the icons on the second mode home screen may be smaller e.g. the same size as those depicted in FIG. 3f). The user could navigate from the second mode home screen to any of the plurality of second mode applications by selecting the corresponding icon (321b, 325b). Another example embodiment may be configured to display all of the available second mode output from a plurality of the second mode applications at the same time.

It will be appreciated that other example embodiments may enable selection of a second mode application in other ways. For example, other example embodiments may be configured to enable selection based on the last running applications. Other example embodiments may enable selection of a user application as a selected second mode application using a physical user interface element or a virtual user interface element (e.g. a physical key). It will be appreciated that other embodiments may be configured to have one or more default second mode applications, the one or more default second mode applications being configured to provide second mode output depending on the number of other user applications having been selected as a second mode application.

It will be appreciated that other example embodiments may have further modes of operation in addition to the first and second modes of operation. For example, an example embodiment may have a third mode wherein all of the user interactions with the portable electronic device are disabled except those which enable the portable electronic device to be changed from the third mode into another mode (e.g. the first mode or the second mode). The third mode may be considered to be a simple background sleep mode.

It will be appreciated that other example embodiments may allow the user to define the second mode output to be displayed in the second mode and how it is displayed. For example, an embodiment may enable a user to configure the portable electronic device such that the map of the route is the second mode output, but that the direction indicator is not the second mode output. It will be appreciated that the second mode output may comprise all of the information relating to the selected second mode application which is available in the first mode of operation. It will be appreciated that the output of the second mode may be predetermined (i.e. before the second mode is entered) or determined whilst the portable electronic device is in the second mode e.g. by user interaction in the second mode. Furthermore, an example embodiment may enable the user to switch the back light of the display screen on and off (e.g. temporarily) whilst in the second mode.

In the above described example, the first and second modes of the portable electronic device were described with respect to a navigation application. It will be appreciated that other applications available on the portable electronic device (e.g. email application, calendar application, movie player application) may be configured to provide different functionality/information when the portable electronic device is in a first or in a second mode of operation.

It will be appreciated that a different subset of the available user applications may have been selected to provide second mode output. For example, the user may have selected the email application (e.g. the specific limited user inputs may allow the user to reply to the last email) and the calendar application (e.g. the specific limited user inputs may allow the user to arrange the meetings scheduled for that day).

It will be appreciated that the second mode applications may be selected whilst the portable electronic device is configured to be in the second mode of operation. For example, if an event occurs relating to a non-second-mode application, whilst the portable electronic device is in the second mode, the apparatus/portable electronic device may be configured to allow the user to select that application as a second mode application, whilst remaining in the second mode. For example, an example embodiment may be configured such that the plurality of second mode applications comprises a navigation application and a music player application. Whilst in the second mode if a message were received, the example embodiment may allow the user to select the corresponding email application in order to allow the user to read the received message whilst in the second mode. For example, the example embodiment may be configured to display an email icon in response to receiving the email message. In this case, if the user selects the displayed email icon, the corresponding email application would be selected as a second mode application and the portable electronic device would then display the received message as second mode output. Alternatively/in addition, the apparatus/portable electronic device may be configured to allow the user to access the received message (in the second mode) by swiping across (or flicking) the screen. For example, whilst the portable electronic device is in a second mode, the user may notice the appearance of a new message icon or indicator. In this case, the apparatus/portable electronic device may be configured such that the user can provide a specific limited user input (e.g. swiping or flicking the screen) to view the corresponding message (e.g. rather than interacting directly with the new message icon or indicator).

It will be appreciated that, other example embodiments may be configured to have different colour schemes in different modes of operation. For example the portable electronic device may be configured to, in a first mode, display (e.g. information such as text, map or image) in colour, and, in the second mode, display in black and white. It will be appreciated that whilst in the second mode of operation, the portable electronic device may be configured to change the display (e.g. present an animation or change the colours of the pixels). Changing the configuration of a pixel may extend the life of that pixel (e.g. by preventing the continuous display of one colour creating a permanent artefact (e.g. burn-in or image persistence)).

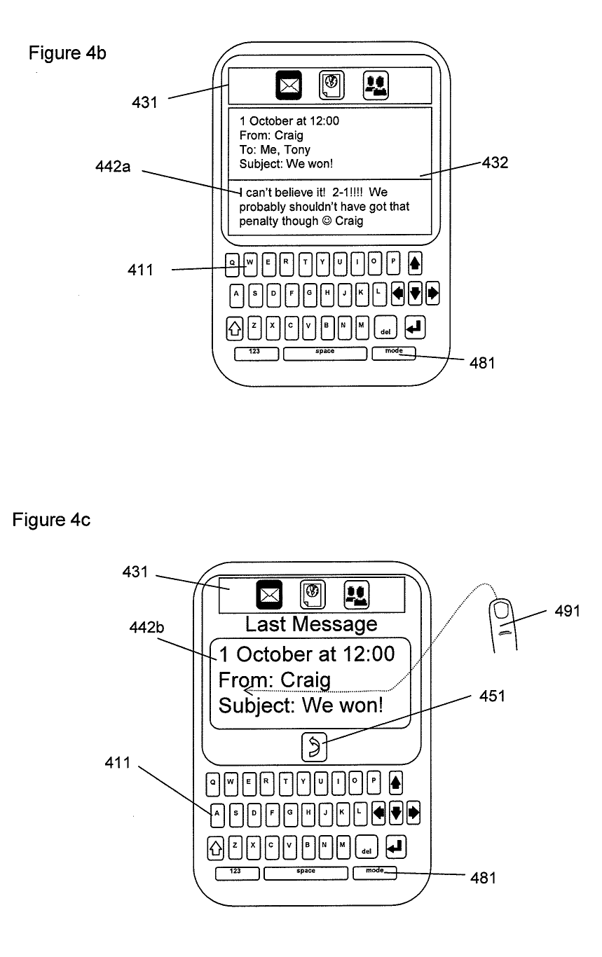

FIG. 4a illustrates a further example embodiment (401) of an apparatus such as a personal digital assistant device comprising a capacitive touch screen (404) configured to display a graphical user interface. This embodiment also comprises a physical key user interface (411) which, in this case, is a virtual QWERTY keyboard. This embodiment is configured to provide three applications in the first mode of operation: an email application, a news feed application and a messaging application.

In the situation depicted in FIG. 4a the user has opened an email application whilst in the first (active) mode of the portable electronic device. When the email application is running, the user interface comprises an icon region (431), and an application region (432). The icon region (431) comprises a number of icons corresponding to the available applications: an email application icon, a news feed application icon, and a messaging application icon. The application icons allow the user to navigate to the corresponding respective application provided by the portable electronic device.

The first (active) mode, in this case, allows for general unlocked user interaction with the user interface of the portable electronic device. That is, the user can interact with the portable electronic device by interacting with the touch screen and/or the physical key user interface. In this case, the first mode is associated with allowing for the availability of one or more of a first level of power consumption and processor activity for the portable electronic device. In this case, the screen brightness is configured to be a first brightness when the portable electronic device is in a first mode of operation.

In the situation depicted in FIG. 4b, the email application is running. The email application region (432) in this case gives a list or recently received emails. He selects the last email he received in order to review it (as depicted in FIG. 4b). The information displayed for the message, when the portable electronic device is in the first mode of operation, comprises information relating to: the date and time the message was received; the sender of the message; the recipients of the message; the subject of the message; and the body text of the message.

When the user has finished reviewing his recently received messages he wishes to put the phone/portable electronic device (401) in his pocket. In order to, for example, save battery life and to reduce the risk of unwanted key presses in his pocket, the user changes the mode of the portable electronic device to a second (standby) mode (e.g. by pressing a mode key (481) for a predetermined period of time). In this case all of the applications available in the first mode of operation are available in the second mode of operations. It will be appreciated that for other example embodiments, only a (partial) subset of the user applications available in the first mode will be available in the second mode of operations. It will be appreciated that the applications available in the second mode may be predetermined and/or pre-selected by the user.

The second (standby) mode of operation is configured to allow locked user interaction with the user interface of the portable electronic device. In this case, the physical key user interface (411) is deactivated (apart from to allow the mode of the device to be changed), whereas one or more specific limited user inputs may be input via the touch screen user interface to directly interact with the associated second mode output. That is the locked user interaction available in the second mode is limited compared to the general unlocked user interaction available in the first mode as the user can interact with the portable electronic device via the physical key user interface (411) or the touch screen user interface (404) in the first mode but only via the touch screen user interface (404) in the second mode (or even just parts of the touch screen user interface (404) in the second mode). In this case, the second mode email application is configured to continuously provide second mode output when the portable electronic device is configured to be in the second mode of operation. That is, in this case, the second mode email application is configured to provide second mode output comprising the last email received. It will be appreciated that other example embodiments may be configured to provide second mode output in response to an event (e.g. a message received from a third party or a scheduled event).

In the situation depicted in FIG. 4c, the portable electronic device is configured to be in the second mode. Information relating to the last received message (442b) is displayed on the touch screen as second mode output. In this case, the second mode output is abbreviated second mode output, as the second mode output is an abbreviated (e.g. redacted) version of the output available in the first mode of operation. In this case, the abbreviated second (standby) mode output (442b) comprises the date and time of the message (although this could be omitted), the sender of the message, and the subject of the message. A selection of these details could be omitted. By providing abbreviated output, the user can quickly and easily see important details of the message without having to change the mode of the portable electronic device.

In this case, the apparatus is configured, in the second mode, to allow for the user to provide one or more specific limited user inputs to the portable electronic device using the touch screen user interface (404) of the portable electronic device (401), to directly interact with associated abbreviated message second mode output (442b) provided using the user interface in the second mode of operation, the one or more specific limited user inputs not being associated with general unlocking of portable electronic device to enter the first mode of operation.

In this case, when the abbreviated second mode output is displayed on the touch screen, the user can provide a specific limited user input by pressing on a record user interface element icon (451) (e.g. using a finger or other stylus). Whilst the specific limited user input is ongoing (e.g. when the icon is being pressed/selected) the apparatus is configured to record a voice message for transmittal to the sender of the displayed message. For example, if the user wishes to quickly reply to the message received with an audio message he may press the record user interface element icon (451) which activates the recordal of a message, whilst the interaction is ongoing (although continuous interaction with the user interface element icon (451) may not be necessary). When the user had finished recording the message, he would release his finger from the record user interface element which would enable transmittal of the recorded message to the sender of the received message. It will be appreciated that when a particular function is activated, the available processing activity and/or power consumption may be temporarily increased. Of course, in another embodiment, the user interface icon (451) may allow the user to type a message by activating the touch screen interface (404) of the key user interface (411).

In this case, the user wishes to quickly review the news headlines so, whilst remaining in the second mode of operation, he selects the news feed application by performing a scrolling gesture on the surface of the touch screen with his finger (491) (or other stylus). In the second mode of operation, the news feed application presents abbreviated second mode output. In this case, the news application abbreviated second mode output comprises the latest news headline. In this case, when the news feed application abbreviated second mode output is displayed on the touch screen, the user can provide a specific user input by pressing on a messaging interface element icon (451) for a predetermined period of time (e.g. using a finger or other stylus). Selecting the messaging interface element icon in this way enables the headline to be posted to a micro-blogging site (or a social networking site).

In this case, the user wishes instead to read the full story so changes the mode of the device to the first mode of operation. In order to do this, the user enters the first (active) mode by manually pressing the mode key (481) for a predetermined period of time. It will be appreciated that other example embodiments may require multiple key strokes or an interaction with multiple keys to switch between modes of operation. Alternatively, the user may touch region 224b to read the full message in the second mode.

When in the first (active) mode, the user can read the full story in the news feed application. This is shown in FIG. 4e. In the first mode, the portable electronic device is configured to enable display all of the first mode output. In this case the first mode output (442a) comprises, in addition to the headline, the content of the news article and pictures relating to the article. When in the first mode, additional interactions are available compared to the interactions available in the second mode. In the first mode, this example embodiment is configured to allow the user to, for example, navigate to other news articles. When the full message is displayed in the second mode, this may displayed using low power output.

It will be appreciated that other example embodiments may have further modes of operation in addition to the first and second modes of operation. For example, an example embodiment may have a third mode (e.g. a simple background mode) wherein all of the user interactions with the portable electronic device are disabled except those which enable the portable electronic device to be changed from the third mode into another mode (e.g. the first mode or the second mode). It will be appreciated that, when in a third mode, the portable electronic device may be configured to change into a second mode in response to an event (e.g. in response to receiving a message, or a scheduled calendar event). It will be appreciated that the apparatus/portable electronic device may be configured to change the mode of the device from a second mode to a first mode in response to interacting with the second mode output (e.g. in order to show the corresponding first mode output). For example, if second mode output comprising a received message were displayed in the second mode the apparatus may be configured to show the corresponding received message first mode output in the first mode in response to the user double clicking (or other user input) the second mode output relating to the received message.

For this embodiment, the messaging application also displays abbreviated second mode output when the portable electronic device is configured to be in the second mode of operation. For example, in the second mode, the application is configured to display only sender information and the first sentence of a message. Furthermore, this example embodiment is configured such that the messaging application only displays second mode output in response to an event (e.g. when a message is received). Like the email application described above, the messaging application also allows specific user input to allow the user to quickly reply the sender of a message whilst remaining in the second mode of operation.

It will be appreciated that, by providing the user with a second mode which allows only specific limited user inputs, the user may interact with the device more intuitively and easily in the second mode. In addition, it may prevent the user from making unwanted or accidental interactions with the portable electronic device whilst retaining useful functionality. It may also allow the battery life of the portable electronic device to be extended. For example, if the user wishes to perform a simple task using the device he may not need to activate the full functionality of the device to do so.

It will be appreciated that other example embodiments may or may not enable the reception of calls (e.g. telephone calls) whilst in the second mode. For example, an example embodiment may, in response to receiving a call, automatically change the mode of the device into the first mode from the second mode. In the first mode, the apparatus would enable general unlocked interaction with the portable electronic device for example, to accept/reject the call and interact with other applications apart from the call application, at least while the call was active. The device may then automatically return the device to the second mode upon the call being finished/rejected. Another example embodiment may enable the reception/acceptance of calls whilst remaining in the second mode of operation and thus not allow general interaction (e.g. with other applications apart from the call application) while the call is active.

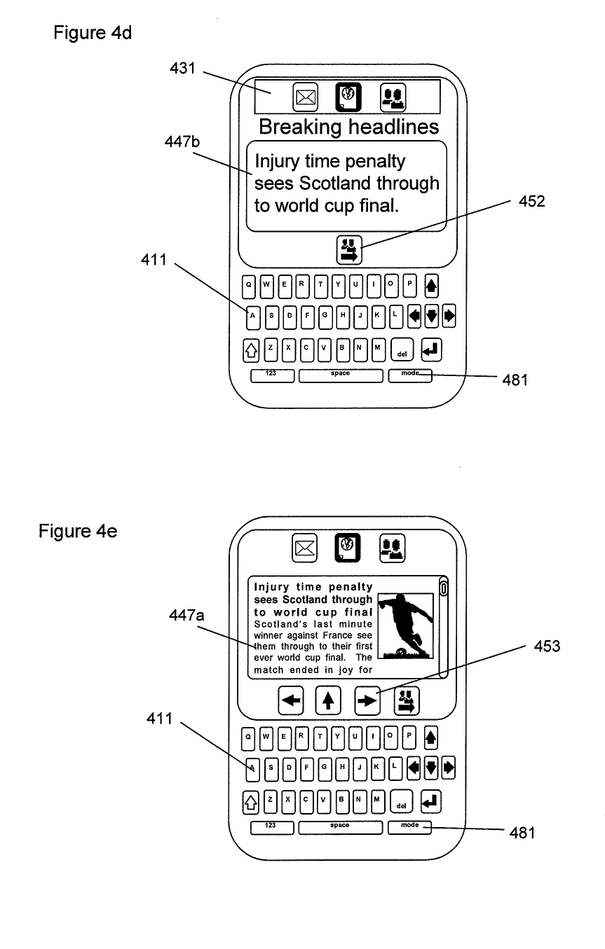

FIG. 5 shows a flow diagram illustrating the operation of different modes of the portable electronic device, and is self-explanatory.

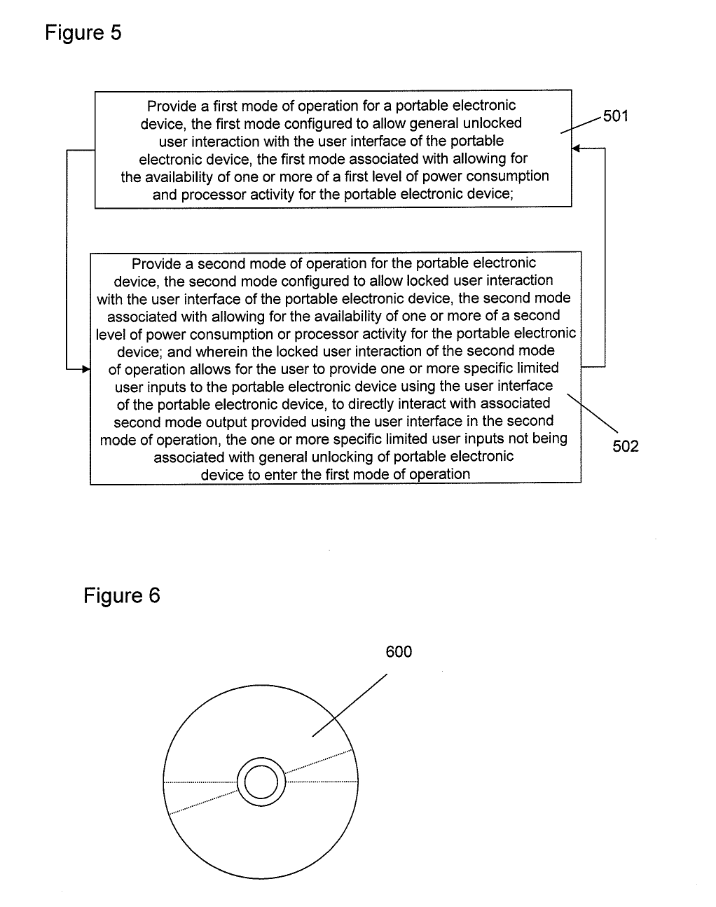

FIG. 6 illustrates schematically a computer/processor readable media 700 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” or processor described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the portable electronic devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

2. The apparatus of claim 1, wherein the associated second mode output comprises output from one or more of a plurality of second mode user applications.

3. The apparatus of claim 2, wherein a plurality of first mode applications are available in the first mode of operation, and the plurality of second mode applications are a subset of the plurality of first mode applications.

4. The apparatus of claim 2, wherein the associated second operating mode output of each of the plurality of second mode applications comprises abbreviated output, abbreviated output being an abbreviated version of output available for the application when in the first mode of operation.

5. The apparatus of claim 2, wherein the specific limited user input allows scrolling between the applications of the plurality of second mode applications.

6. The apparatus of claim 2, wherein each said second mode application is a first mode application.

7. The apparatus of claim 4, wherein the abbreviated output comprises one or more of:
a subject of a textual message;
a first line of a textual message;
information identifying the sender of a textual message;
a news headline;
a direction indicator; and
a location indicator.

8. The apparatus of claim 2, wherein the plurality of user applications comprises one or more of:
an email application;
a navigation application;
a social networking application;
a news feed application;
a web browser; and
a map application.

9. The apparatus of claim 1, wherein, when in the second mode of operation, the second mode output comprises navigation information associated with a navigation application, and the allowable specific limited user input includes changing the location of the portable electronic device;
information relating to a received message from a third party and the specific limited user input enables recording an audio message, and transmitting the recorded message to the third party; and
information relating to the music file being played and the specific limited user input enables the user to select a different music file to be played.

10. The apparatus of claim 1, wherein the specific limited user input is limited with respect to the general range of user input available in the first mode.

11. The apparatus of claim 1, wherein the second mode output is a low power output with respect to the output available in the first mode of operation.

12. The apparatus of claim 1, wherein the second level of the one or more of power consumption and processor activity is lower than the first level of the one or more of power consumption and processor activity for the portable electronic apparatus.

13. The apparatus of claim 1 wherein the second mode of operation allows for the user to provide specific limited user input to the portable electronic device using the user interface of the portable electronic device, to directly interact with associated output provided using the user interface in the second mode of operation, whilst keeping the portable electronic device in the second mode.

14. The apparatus of claim 1, the apparatus configured to provide a third mode of operation for the portable electronic device, the third mode associated with allowing for the availability of one or more of a third level of power consumption or processor activity for the portable electronic device, the third level of one or more of power consumption and processor activity being lower than the second level.

15. The apparatus of claim 1, wherein the locked user interactions of the second mode are locked with respect to the availability of one or more of the power source, processor and functionality of the user interface.

16. The apparatus of claim 1 wherein one or more of the second level of power consumption and processor activity for the portable electronic device are temporarily higher than the first level of power consumption and processor activity for the portable electronic device during processing and/or performance of the specific limited user input and/or the function/task associated with the specific limited user input.

17. The apparatus of claim 1, wherein a specific limited user input comprises:
tilting the portable electronic device;
moving the portable electronic device to a new location;
interacting with a touch screen;
pressing a touch screen;
hovering over a touch screen;
touching a particular region of the touch screen;
pressing a key; and
swiping on the touch screen.

18. The apparatus according to claim 1, wherein the apparatus is at least one of a portable electronic device, circuitry for a portable electronic device, a laptop computer, a desktop computer, a mobile phone, a Smartphone, a tablet PC, a monitor, a personal digital assistant or a digital camera or a module for the same.

19. A method, the method comprising:
providing a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
providing a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.

20. A computer program comprising computer program code configured to:
provide a first mode of operation for a portable electronic device, the first mode configured to allow general unlocked user interaction with the user interface of the portable electronic device, the first mode associated with allowing for the availability of one or more of a first level of power consumption and processor activity for the portable electronic device;
provide a second mode of operation for the portable electronic device, the second mode configured to allow locked user interaction with the user interface of the portable electronic device, the second mode associated with allowing for the availability of one or more of a second level of power consumption or processor activity for the portable electronic device; and
wherein the locked user interaction of the second mode of operation allows for the user to provide one or more specific limited user inputs to the portable electronic device using the user interface of the portable electronic device, to directly interact with associated second mode output provided using the user interface in the second mode of operation, the one or more specific limited user inputs not being associated with general unlocking of portable electronic device to enter the first mode of operation.
